(19) United States
(12) Patent Application Publication
(10) Pub. No.: US 2006/0011882 A1
(43) Pub. Date: Jan. 19, 2006

(54) Control Valve with Elastomeric Valve Element

(75) Inventors: Heiko Arndt, Flensburg (DE); Peter Gravesen, Nordborg (DK)

Correspondence Address: MCCORMICK, PAULDING & HUBER LLP, CITY PLACE II, 185 ASYLUM STREET, HARTFORD, CT, 06103, US

(73) Assignee: Danfoss A/S, Nordborg (DK)

(21) Appl. No.: 10/527,079

(22) PCT Filed: Sep. 12, 2003
(86) PCT No.: PCT/DK03/00593

§ 371 Date: May 31, 2005

(30) Foreign Application Priority Data
Sep. 13, 2002 (DK) PA 2002 01350

(51) Int. Cl. F16K 7/20

(52) U.S. Cl. 251/318

(57) ABSTRACT

This invention relates to control valves for controlling of fluid flow, where the flow-controlling element in the valve body is of an elastomeric material. The control valve has only one flow-controlling element, which element fulfils all functions of the valve, meaning non-return function, flow-restriction function and/or controlling function.

### CROSS REFERENCE TO RELATED APPLICATIONS

This application is entitled to the benefit of and incorporates by reference essential subject matter disclosed in international Patent Application No. PCT/DK2003/000593 filed on Sep. 12, 2003 and Danish Patent Application No. PA 2002 01350 filed on Sep. 13, 2002.

### FIELD OF THE INVENTION

This invention relates to control valves for controlling fluid flow.

### BACKGROUND OF THE INVENTION

A valve of this kind is known from U.S. Pat. No. 5,267,585, where an elastomeric ball-shaped element is placed inside a control chamber of a flow control valve. By pressing this ball-shaped elastomeric element it will deform, and hereby reduce the flow volume from an inlet passage to an outlet passage in the valve body. Completely pressing the element will completely block the flow volume, whereby the valve will be closed.

The valve disclosed in U.S. Pat. No. 5,267,585 consists of a number of different parts, which has to be assembled to form the valve. Also the valve will be fully open in an unactivated situation, and the fluid flow will have no impact on the degree of opening. A limitation of the flow will thus need a separate valve connected in a serial matter with the flow through the control valve.

A flow control valve will usually influence the degree of flow by a relative movement between a valve member and valve body, as is the case with the valve of U.S. Pat. No. 5,267,585. In the following flow control function is to be understand as any controlled influence the flow control valve will give to the degree of fluid flow, either due to the rate of fluid flow itself or due to an activation of the valve.

### SUMMARY OF THE INVENTION

It is an object of this invention to simplify the manufacturing of a control valve. It is a further object of this invention to provide a control valve, which will be closed in an unactivated situation. It is yet a further object of this invention to provide a control valve where the fluid flow will influence the degree of opening of the control valve.

The object of this invention is achieved in that flow forces from fluid communicated from one of the fluid passages to the other of the fluid passages will act on the elastomeric element and hereby form at least a part of the flow control function. Hereby is achieved that limitations in rate of fluid flow or in direction of fluid flow are made as self-acting controls inside the control valve, obtained by proper dimensioning of the elements of the valve.

Preferably the level of the flow forces, needed to perform at least a part of the flow function, is lower from the fluid outlet passage to the fluid inlet passage, than from the fluid inlet passage to the fluid outlet passage. Hereby is achieved that a flow rate restriction and a non-return function is obtained inside one valve and by only one closing or restriction member.

In one embodiment of the invention only the flow forces forms the flow control function. Hereby is obtained that a self-acting flow direction control valve can be made very simple.

In another embodiment of the invention, an actuating member is fixed to the elastomeric element, and the flow control function is, in addition to being formed by the flow forces, formed by activating the actuating member. Hereby is achieved that an external control function is added to the valve, however still using only one closing or restriction member.

Preferably the elastomeric element, when the actuating member is not activated, prevents the fluid inlet passage from being in fluid communication with the fluid outlet passage. This will give a normally closed valve, meaning a valve, which is closed when no forces are applied to the valve.

Preferably the control chamber, when the actuating member is not activated, is completely filled by the elastomeric element. Hereby is achieved that the elastomeric element can be moulded inside the control chamber, whereby production of the valve is very simple.

In one embodiment of the invention the elastomeric element, when the actuating member is activated, will be influenced by the flow forces, and by exceeding a certain level of flow forces will separate the fluid outlet passage from fluid communication with the control chamber. Hereby is obtained that an excessive flow rate will lead to a closing of the valve, whereby flow is prevented until normal pressure conditions between inlet and outlet of the valve is obtained.

Now having described the invention in general terms, detailed embodiments of the invention is to be described with reference to the drawings:

### BRIEF DESCRIPTION OF THE DRAWINGS

FIG. 1 is a sectional view of one embodiment of the invention in closed position;

FIG. A is a sectional view of FIG. 1;

FIG. 2 is a sectional view of one embodiment of the invention in open position;

FIG. 2A is a sectional view of FIG. 2;

FIG. 3 is a sectional view of one embodiment of the invention in open position and influenced by flow forces;

FIG. 3A is a sectional view of FIG. 3;

FIG. 4 is a sectional view of a second embodiment of the invention in closed position;

FIG. 4A is a sectional view of FIG. 4;

FIG. 5 is a sectional view of a second embodiment of the invention in open position;

FIG. 5A is a sectional view of FIG. 5;

FIG. 6 is a sectional view of a second embodiment of the invention in open position and influenced by flow forces;

FIG. 6A is a sectional view of FIG. 6;

FIG. 7 is a sectional view of a third embodiment of the invention in an uninfluenced situation;

FIG. 8 is a sectional view of a third embodiment of the invention in one influenced situation; and

FIG. 9 is a sectional view of a third embodiment of the invention in another influenced situation.

### DETAILED DESCRIPTION OF THE PREFERRED EMBODIMENTS

Reference numbers on each figure is kept identical for equivalent elements. This means that following reference list will indicate elements in all figures where the reference is used.
Ref. 1: Valve body
Ref. 2: Fluid inlet passage
Ref. 3: Fluid outlet passage
Ref. 4: Elastomeric valve element
Ref. 5: End part
Ref. 6: End part
Ref. 7: Actuating member
Ref. 8: Support element
Ref. 9: Screws
Ref. 10: Arrow
Ref. 11: Fluid flow volume
Ref. 12: Slots
Ref. 13: Top part of elastomeric valve body
Ref. 14: Control part of elastomeric valve body

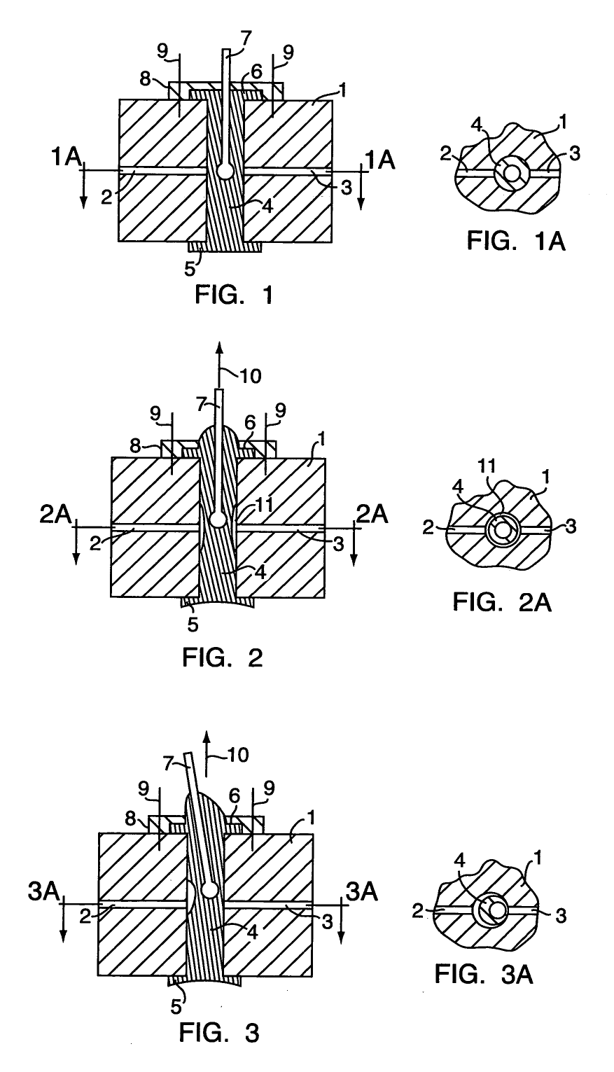

Turning now to FIG. 1, a valve body 1 includes a fluid inlet passage 2 and a fluid outlet passage 3. A control chamber is formed as a bore radial to the two fluid passages, and in this bore an elastomeric element 4 is placed. The elastomeric element has two end parts 5 and 6, each with a larger diameter than the body of the elastomeric element 4. The elastomeric element is moulded inside the valve body, and the two end parts 5 and 6 are for the purpose of retaining the elastomeric element in the valve body.

An activating member 7 is fixed by moulding inside the elastomeric element, and is extending to the external of the valve body. A supporting member 8 is placed on the side of the valve body where the actuating member is extending, hereby giving an additional support for the elastomeric element against the influence from activating of the actuating member. The supporting member 8 is mounted to the valve body by means of screws, indicated as position 9.

As the elastomeric element is moulded inside the valve body, the control chamber is completely filled with the elastomeric element. Fluid is thus unable to flow from the inlet passage 2 to the outlet passage 3, or reverse, when the actuating member is inactivated like in FIG. 1.

Sectional view 1A-1A of FIG. 1 is shown in FIG. 1A, where it is to be seen that the elastomeric element completely fills the control chamber.

FIG. 2 shows the valve of FIG. 1, only in open position. Actuating member 7 is pulled in the direction indicated by arrow 10, whereby a contracting of the elastomeric element occurs in the area where the fluid passages 2 and 3 are connected to the control chamber. This contraction leaves free volume for fluid flow, indicated as position 11 at FIGS. 2 and 2A.

Most elastomeric materials have a constant volume. Therefore, contracting of an elastomeric element at one position means expanding of the same elastomeric element at another position. On FIG. 2 this material expansion is to be seen as a bulge through a hole in the supporting member 8, following the direction of force 10 on the actuating member 7. A certain deformation of the elastomeric element must be possible, either by some free volume or deformation of the support member 8. Also the exact position of the end point of the actuating member has to be in accordance with the geometry of the whole control valve. The position of the end point will move from FIG. 1 to FIG. 2, which is to be seen on the drawings.

As no fluid will be contained inside the control chamber when the actuating member is not activated, the valve offers a possibility of exact dosage of a fluid from inlet passage 2 to outlet passage 3.

An additional function of the control valve can be explained from FIGS. 3 and 3A. When the actuating member is activated, and the fluid thus is able to flow from fluid inlet passage 2 to fluid outlet passage 3, flow forces from the flow of fluid will act on the elastomeric element in the opening zone 11. These forces will force the elastomeric element in the flow direction, and at a given level of forces the fluid outlet passage 3 will be blocked by the elastomeric element 4. This means that the valve, in addition to its control function, has a flow restricting function, by which the flow will be limited to a given level. Of cause this means that the actuating member has to be either able to bend with the elastomeric element, or must be connected in a flexible way to the pulling actuator. This flexible connection can easily be obtained, as the movement is very limited.

FIGS. 3 and 3A also shows how the fluid moving the elastomeric element affects the actuating member 8. The position of the end point of the actuating member is following the flow direction, and hence of the movement of the elastomeric element, toward the outlet passage 3. The opposite end of the actuating member, being outside the valve, is moved against the flow direction.

The pulling actuator for activating the actuating member could be substituted by a pushing actuator. The fixing point for the actuating member in the elastomeric element must be optimised for either pulling or pushing, but contraction of the elastomeric element in the area where the fluid passages 2 and 3 are connected to the control chamber will occur by pulling as well as by pushing.

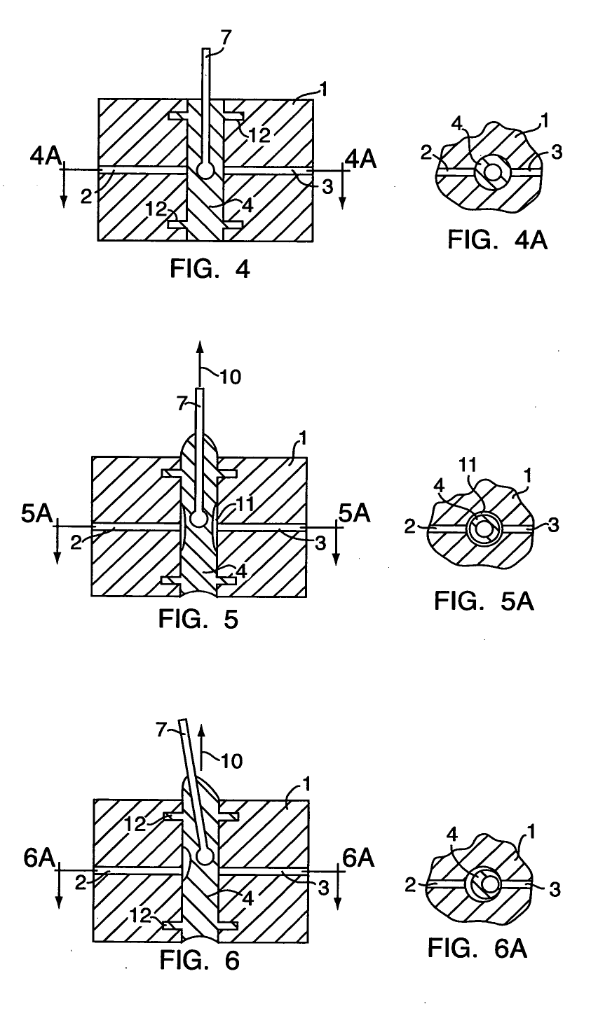

FIG. 4-6 shows another embodiment than that of FIG. 1-3, where slots 12 in the valve body, into which the elastomeric element is moulded, form the support of the elastomeric element 4. Further explanation shall not be made to the valve of FIG. 4-6, as all numbers and functions are identical to FIG. 1-3, except for the support of the elastomeric element.

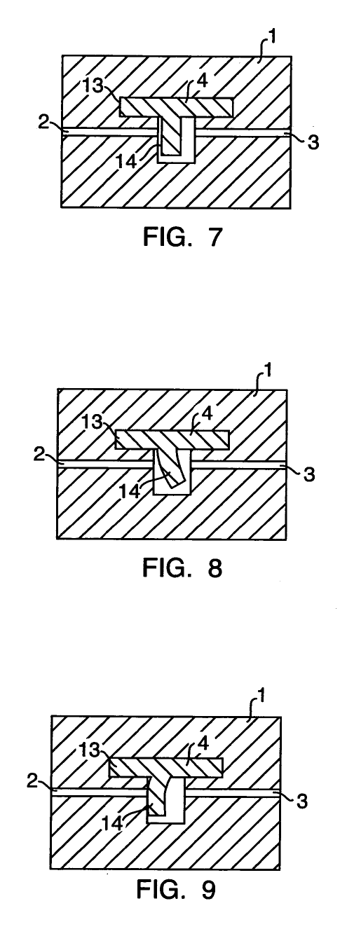

FIG. 7 shows a valve body 1, with a fluid inlet passage 2 and a fluid outlet passage 3. Inside the valve body is a control chamber, which is partly filled by an elastomeric element 4. The elastomeric element 4 has a base part 13, which is fixed in the top part of the control chamber, and a control part 14, which is able to move inside the bottom part of the control chamber, however fixed to the top part 13 of the elastomeric element. The control part 14 is placed closer to the fluid inlet passage than to the fluid outlet passage.

FIG. 8 shows the valve of FIG. 7 in a situation where fluid flows from fluid inlet passage 2 to fluid outlet passage 3. The control part 14 of the elastomeric element is by the flow forces from the fluid flow forced in the flow direction towards the fluid outlet passage 3. At a certain level of flow, the control part 14 will block the fluid outlet passage, hereby offering a flow restriction function.

FIG. 9 shows the valve of FIG. 7 in a situation where fluid flows, or attempts to flow, from fluid outlet passage 3 to fluid inlet passage 2. The control part 14 of the elastomeric element will block the fluid inlet passage due to the flow forces and the pressure difference, hereby offering a non-return function.

The level at which the non-return function and the flow restriction function will be activated depends on the position and the geometry of the control part 14 of the elastomeric element 4. Placed concentric in the control chamber the non-return function and the flow restriction function will be identically, and moving the control part 14 to a more and more eccentric position will give more and more distance between the level at which the two functions are activated.

While the present invention has been illustrated and described with respect to a particular embodiment thereof, it should be appreciated by those of ordinary skill in the art that various modifications to this invention may be made without departing from the spirit and scope of the present invention.

What is claimed is:

1. A flow control valve comprising: a valve body having a control chamber formed within said valve body, said control chamber being in fluid communication with a fluid inlet passage and a fluid outlet passage; an elastomeric element being placed inside said control chamber; an actuating member being placed in connection with said elastomeric element, said actuating member preventing fluid to be communicated from one of said fluid passages to the other of said fluid passages when it is not activated, wherein when the actuating member is activated, flow forces from a flow of fluid will act upon the elastomeric element in an opening zone, forcing the elastomeric element in the flow direction.

2. The flow control valve in accordance with claim 1, wherein least a part of said actuating member is able to move with said elastomeric element, so that when flow forces from the flow of fluid act upon the elastomeric element in the opening zone, the elastomeric element and at least a part of the actuating member are forced in the flow direction.

3. The flow control valve in accordance with claim 1, wherein flow forces from fluid communicated from one of said fluid passages to the other of said fluid passages will act upon said elastomeric element, thus forming at least a part of the flow control function.

4. The flow control valve in accordance with claim 1, wherein when the actuating member is not activated, the end point of said actuating member is in the area where the fluid passages are connected to said control chamber.

5. The flow control valve an accordance with claim 1, wherein when the actuating member is activated, the end point of said actuating member is moved away from the area where the fluid passages are connected to said control chamber.

6. The flow control valve in accordance with claim 5, wherein when said actuating member is activated, the end point of the actuating member is forced in the flow direction of the fluid, when flow forces from the flow of fluid act upon said elastomeric element in the opening zone, forcing the elastomeric element in the flow direction.

7. The flow control valve comprising: a valve body having a control chamber formed within said valve body, the control chamber being in fluid communication with a fluid inlet passage and a fluid outlet passage; and an elastomeric element being placed inside said control chamber, wherein the elastomeric element has a control part placed eccentrically inside the control chamber.

8. (canceled)
